(19) United States
(12) Patent Application Publication
(10) Pub. No.: US 2016/0301667 A1
(43) Pub. Date: Oct. 13, 2016

(54) SYSTEM FOR DIVIDING NETWORK USING VIRTUAL PRIVATE NETWORK AND METHOD THEREFOR

(71) Applicant: NSOLUTION CO., LTD., Gyeonggi-do (KR)

(72) Inventor: Dong-Yoon HYUN, Hwaseong-si, Gyeonggi-do (KR)

(73) Assignee: NSOLUTION CO., LTD., Anyang-si (KR)

(21) Appl. No.: 14/917,348

(22) PCT Filed: Aug. 30, 2013
(86) PCT No.: PCT/KR2013/007837

§ 371 Date: Mar. 8, 2016

(30) Foreign Application Priority Data
Apr. 1, 2013 (KR) 10-2013-0035142
Jul. 30, 2013 (KR) 10-2013-0090110

(51) Int. Cl. H04L 29/06

(52) U.S. Cl. CPC H04L 63/0272

(57) ABSTRACT

The present invention relates to a technology for enabling each user's PC to transmit a packet separately through an internal network or external network by means of a virtual private network almost without changing the existing network environment in a network division system for physically dividing PCs into a group for accessing the internal network and a group for accessing the external network. To this end, the present invention does not allow the connection between an internal network PC and an external network PC through a network division apparatus, does not allow the internal network PC to connect to an encoded gateway, and does not allow the external network to connect through the encoded gateway to the internal network, but enables the internal network PC to connect to the internal network, and the external network PC to connect through a virtual private network to the external network.

### TECHNICAL FIELD

The present disclosure relates to a network division technology for separating and transmitting packets transmitted from a user's terminal to an internal network or external network, and more particularly, a network division system and method using a virtual private network, which enables each user's PC to transmit a packet through an internal network or external network by means of a virtual private network almost without changing the existing network environment in a network division system which physically divides PCs into a group for accessing the internal network and a group for accessing the external network.

### BACKGROUND ART

Recently, research and development have been actively conducted on computers and networks. Thus, users working for public institutions or firms can transmit data or files to the other parties or receive data or files from the other parties, using an internal network (private network) or external network such as the Internet, regardless of time and place.

In general, when users transmit data or files to the other parties or receive data or files from the other parties, an internal network for inner workings and an external network such as the Internet are used together. In such a network system, a person with an impure intention may access the internal network through the external network and take or damage important information or files.

Thus, research and development have been actively conducted on the network division technology which divides and operates an internal network and an external network, in order to prevent a threat which may occur when a person with an impure intention accesses the internal network through the external network and takes or damages important information or files.

The network division technology refers to the technology which divides networks for different uses and blocks data transmission or reception from any one network to another network, such that although the one network becomes vulnerable to a security threat, the other network is not damaged.

The network division technology may be divided into physical network division and logical network division. The physical network division is to build physically divided networks by constructing equipment and data cables for each of the networks. The logical network division is divided into an SBC (Sever Based Computing) method and a PC virtualization method. According to the SBC method, a plurality of users access one server system so as to connect to an external network. According to the PC virtualization method, a user connects to an external network through OS (Operating System) virtualization on the user's PC.

When the physical network division of the conventional network division technology is used, network equipment, facilities, and user PCs must be constructed for each of the divided networks. Thus, the physical network division costs too much.

Furthermore, when the logical network division of the conventional network division technology is used, the logical network division is affected by the OS of a server or user PC. Thus, a trouble frequently occurs due to the OS change, and related programs in use need to be updated according to the environmental change. As a result, users' convenience and work efficiency are inevitably degraded.

### DISCLOSURE

### Technical Problem

Various embodiments are directed to a network division system and method using a virtual private network, which enables each user's PC to transmit a packet through an internal network or external network by means of a virtual private network almost without changing the existing network environment in a network division system which physically divides PCs into a group for accessing the internal network and a group for accessing the external network.

### Technical Solution

In an embodiment, a network division system using a virtual private network may include: an external network PC and internal network PC connected to a plurality of network division apparatuses; a virtual private network and internal network connected to the network division apparatuses; and an external network. The network division system may extract the destination IP addresses of packets transmitted or received to the internal network PC or the internal network and the destination IP addresses of packets transmitted or received to the external network PC or the virtual private network, and block a part of the packets transmitted or received to the internal network PC or the internal network and a part of the packets transmitted or received to the external network PC or the virtual private network, based on the extracted IP addresses.

In another embodiment, a network division system using a virtual private network may include: an external network PC and internal network PC connected to a plurality of network division apparatuses; a virtual private network and internal network connected to the network division apparatuses; and an external network. The network division apparatus may include: a first bridge interface configured to transmit or receive packets between the internal network PC and the internal network; a second bridge interface configured to transmit or receive packets between the external network PC and the virtual private network; a first packet analysis part configured to extract the destination IP addresses of packets transmitted or received between the first bridge interface and the internal network PC or the internal network and the destination IP addresses of packets transmitted or received between the second bridge interface and the external network PC or the virtual private network; and a first packet processing part configured to block a part of the transmitted or received packets, based on the extracted IP addresses.

In another embodiment, a network division method using a virtual private network may include: analyzing the destination IP address of a packet received to a network division apparatus from an external network PC, and blocking transmission of the packet when the packet is a packet headed for an internal network PC or internal network or allowing transmission of the packet when the packet is a packet headed for an external network; and analyzing the destination IP address of a packet received to the network division apparatus from the internal network PC, and blocking transmission of the packet when the packet is a packet headed for the external network PC or a virtual private network or allowing transmission of the packet when the packet is a packet headed for the internal network.

### Advantageous Effects

According to the embodiments of the present invention, the network division system and method enables each user's PC to transmit a packet through an internal network or external network by means of a virtual private network almost without changing the existing network environment in a network division system which physically divides PCs into a group for accessing the internal network and a group for accessing the external network. Thus, an operational vacuum caused by a software error occurring in the logical network division can be removed to minimize the cost which is increased by trouble shooting and work delay.

Furthermore, the network division can be performed only through the minimum change of the existing network without physical dividing the external network and the internal network. Thus, the cost required for network division can be minimized.

### BRIEF DESCRIPTION OF DRAWINGS

FIG. 1 is a block diagram of a network division system using a virtual private network according to an embodiment of the present invention.

FIG. 2 is a detailed block diagram of a network division apparatus and an encoded gateway in FIG. 1.

FIGS. 3A, 3B, 4A, 4B, and 5 are control flowcharts a network division method using a virtual private network according to an embodiment of the present invention.

FIG. 6 is a conceptual view illustrating connections of the network division system using a virtual private network according to the embodiment of the present invention.

### MODE FOR INVENTION

Hereafter, exemplary embodiments of the present invention will be described in detail with reference to the accompanying drawings.

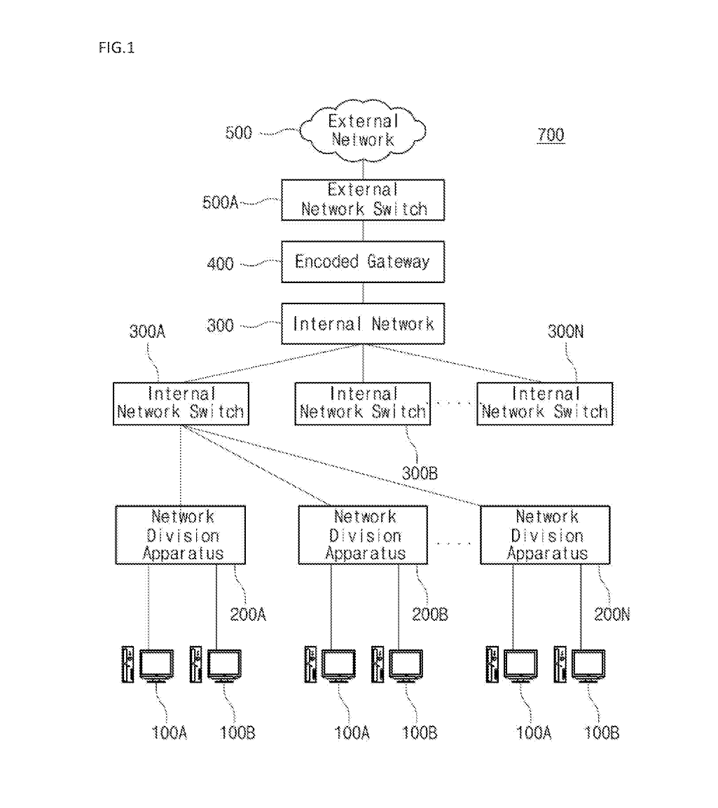

FIG. 1 is a block diagram of a network division system using a private network according to an embodiment of the present invention. As illustrated in FIG. 1, the network division system 700 includes an internal network PC 100A, an external network PC 100B, a plurality of network division apparatuses 200A to 200N, a plurality of internal network switches 300A to 300N, an internal network 300, an encoded gateway 400, an external network switch 500A, an external network 500, and a virtual private network (not illustrated). The internal network PC 100A indicates a PC which is connected to the internal network 300, and the external network PC 100B indicates a PC which is connected to the external network 500.

The internal network PC 100A and the external network PC 100B are connected to the corresponding network division apparatus among the plurality of network division apparatuses 200A to 200N. Each of the internal network switches 300A to 300N is connected to the network division apparatuses 200A to 200N. The plurality of internal network switches 300A to 300N are connected to the internal network 300. The encoded gateway 400 is connected to the internal network 300 at one side thereof, and connected to the external network 500 at the other side thereof through the external switch 500A. The virtual private network may be connected between the network division apparatuses 200A to 200N and the encoded gateway 400.

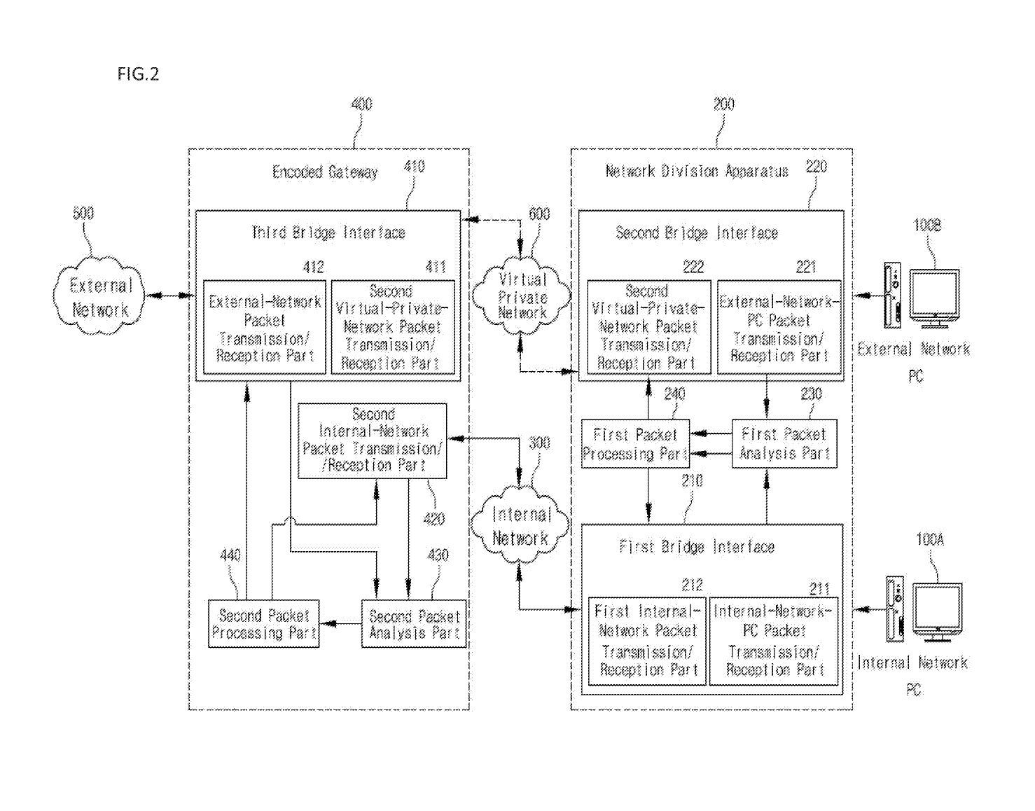

FIG. 2 is a detailed block diagram of the network division apparatus 200 and the encoded gateway 400 in the network division system 700. Referring to FIG. 2, the network division apparatus 200 may indicate an arbitrary network division apparatus among the plurality of network division apparatuses 200A to 200N in FIG. 1, and include a first bridge interface 210, a second bridge interface 220, a first packet analysis part 230, and a first packet processing part 240.

Referring to FIGS. 1 and 2, a network division operation of the network division system using a virtual private network will be described as follows.

The first bridge interface 210 includes an internal-network-PC packet transmission/reception part 211 and a first internal-network packet transmission/reception part 212. The internal-network-PC packet transmission/reception part 211 transmits or receives a packet to or from the internal network PC 100A, and is connected to the first internal-network packet transmission/reception part 212. The first internal-network packet transmission/reception part 212 transmits or receives a packet to or from the internal network 300.

The second bridge interface 220 includes an external-network-PC packet transmission/reception part 221 and a first virtual-private-network packet transmission/reception part 222. The external-network-PC packet transmission/reception part 221 transmits or receives a packet to or from the external network PC 100B, and is connected to the first virtual-private-network packet transmission/reception part 222. The first virtual-private-network packet transmission/reception part 222 transmits or receives a packet to or from the virtual private network 600.

The first packet analysis part 230 analyzes packets received to the first bridge interface from the internal network PC 100A, extracts the destination IP addresses of the packets, and transmits the extracted destination IP addresses to the first packet processing part 240. Furthermore, the first packet analysis part 230 analyzes packets received to the second bridge interface 220 from the external network PC 100B, extracts the destination IP addresses of the packets, and transmits the extracted destination IP addresses to the first packet processing part 240.

The first packet processing part 240 analyses the destination IP addresses received from the first packet analysis part 230, and controls the packet transmission operation of the first bridge interface 210 to block packets transmitted to the external network PC 100B from the internal network PC 100A or pass packets transmitted to the internal network 300 from the internal network PC 100A, based on the analysis result for the destination IP addresses. Furthermore, based on the destination IP address analysis result received from the first packet analysis part 230, the first packet processing part 240 controls the packet transmission operation of the second bridge interface 220 to block packets transmitted to the internal network PC 100A from the external network PC 100B or pass packets transmitted to the virtual private network from the external network PC 100B.

The encoded gateway 400 includes a third bridge interface 410, a second internal-network packet transmission/reception part 420, a second packet analysis part 430, and a second packet processing part 440.

The third bridge interface 410 includes a second virtual-private-network packet transmission/reception part 411 and an external-network packet transmission/reception part 412. The second virtual-private-network packet transmission/reception part 411 transmits or receives a packet to or from the virtual private network 600, and is connected to the external-network packet transmission/reception part 412. The external-network packet transmission/reception part 412 transmits or receives a packet to or from the external network 500.

The second internal-network packet transmission/reception part 420 is connected to the internal network 300.

The second packet analysis part 430 analyzes packets transmitted or received from the second virtual-private-network packet transmission/reception part 411 and the external-network packet transmission/reception part 412 of the third bridge interface 410, and the second internal-network packet transmission/reception part 420, extracts the destination IP addresses of the packets, and transmits the extracted destination IP addresses to the second packet processing part 440.

The second packet processing part 440 analyzes the destination IP addresses received from the second packet analysis part 430. When the corresponding packet is determined to be a packet headed for the external network PC 100B after being received from the external network 500, based on the destination IP address analysis result, or a policy is set to allow connection to the external network PC 100B for a packet received from the external network 500, the second packet processing part 440 controls the packet transmission operation of the third bridge interface 410 to transmit the packet to the external network PC 100B.

However, when the corresponding packet is determined to be a packet headed for the internal network 300 based on the destination IP address analysis result, the second packet processing part 440 controls the packet transmission operation of the third bridge interface 410 to block the packet.

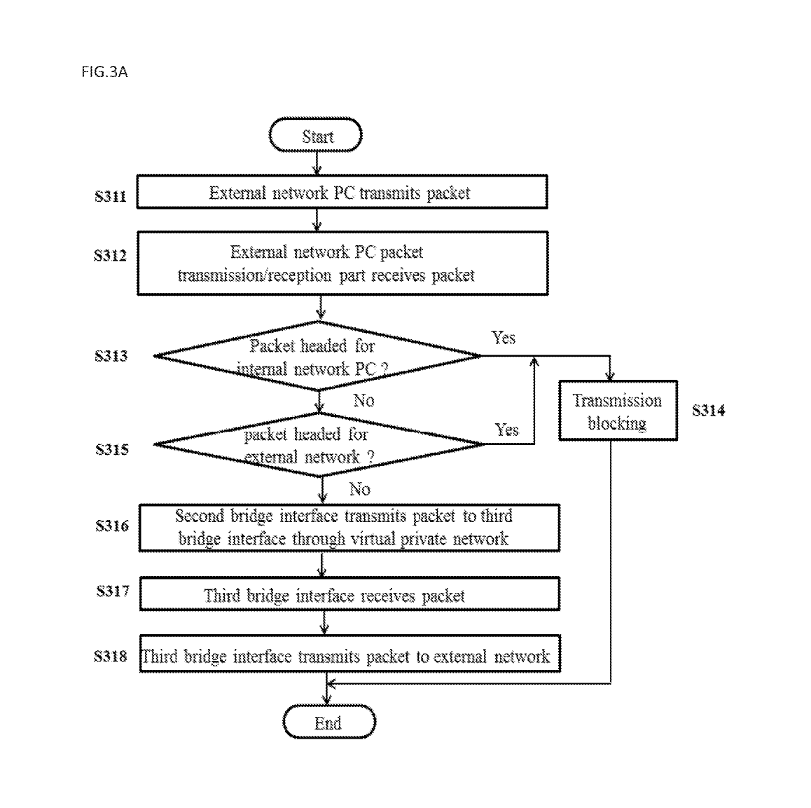

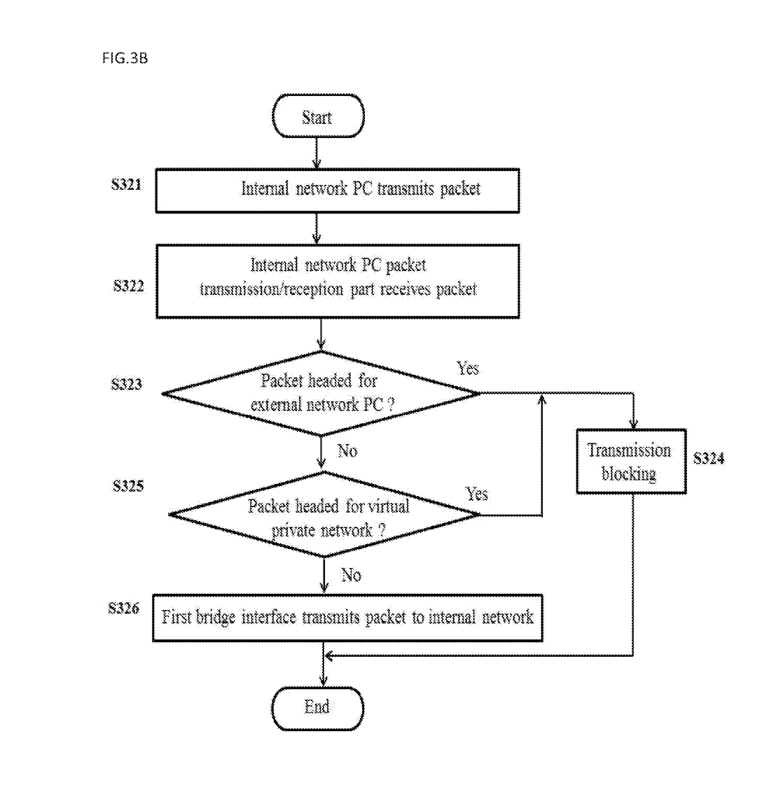

FIGS. 3 to 5 are control flowcharts of a network division method using a virtual private network according to an embodiment of the present invention. Referring to FIGS. 3 to 5, the network division method according to the embodiment of the present invention will be described as follows.

Referring to FIG. 3A, when a user transmits a packet on the external network PC 100B, the external-network-PC packet transmission/reception part 221 receives the packet transmitted from the external network PC 100B, at steps S311 and S312.

At this time, the first packet analysis part 230 extracts the destination IP address from the packet received by the external-network-PC packet transmission/reception part 221, and transmits the extracted destination IP address to the first packet processing part 240. Then, the first packet processing part 240 analyzes the IP address received from the first packet analysis part 230. When the corresponding packet is determined to be a packet headed for the internal network PC 100A, the first packet processing part 240 blocks transmission of the packet at steps S313 and S314.

However, when the corresponding packet is determined to be a packet headed for the external network 500 based on the IP address analysis result received from the first packet analysis part 230, the packet transmitted from the external network PC 100B is processed through the external-network-PC packet transmission/reception part 221 and the first virtual-private-network packet transmission/reception part 222 of the second bridge interface 220, and then transmitted to the third bridge interface 410 of the encoded gateway 400 through the virtual private network 600, at steps S315 and S316.

The third bridge interface 410 receives the packet transmitted from the virtual private network 600, and then transmits the received packet to the external network 500, at steps S317 and S318.

Referring to FIG. 3B, when a user transmits a packet on the internal network PC 100A, the internal-network-PC packet transmission/reception part 211 receives the packet transmitted from the internal network PC 100A, at steps S321 and S322.

At this time, the first packet analysis part 230 extracts the destination IP address from the packet received by the internal-network-PC packet transmission/reception part 211, and transmits the extracted destination IP address to the first packet processing part 240. Then, the first packet processing part 240 analyzes the IP address received from the first packet analysis part 230. When the packet is determined to be a packet headed for the external network PC 100B or the virtual private network 600, the first packet processing part 240 blocks transmission of the packet, at step S323 to S325.

However, when the packet transmitted from the internal network PC 100A is determined to be a packet headed for the internal network 300, the first bridge interface 210 transmits the packet to the internal network 300 at step S326.

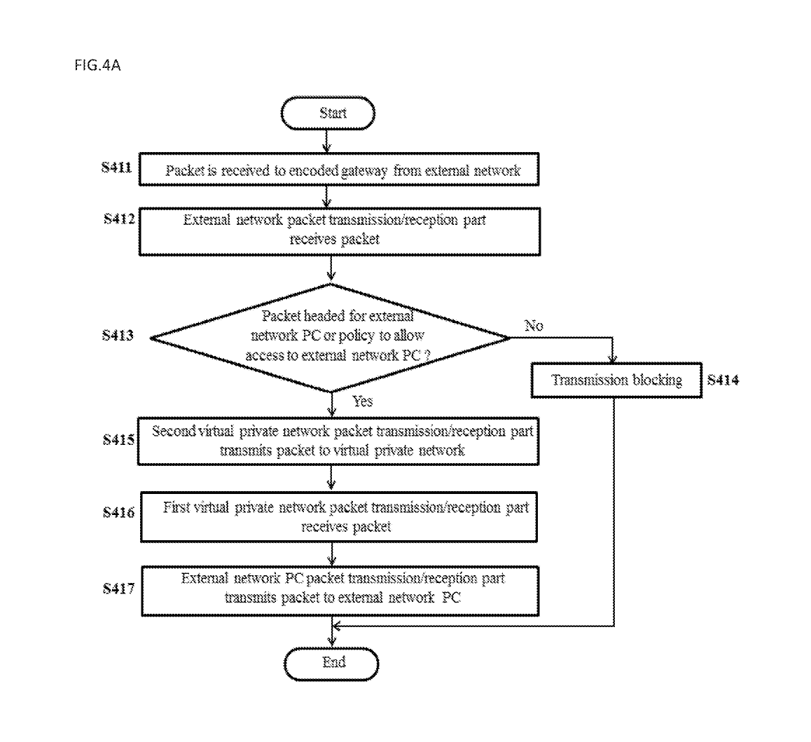

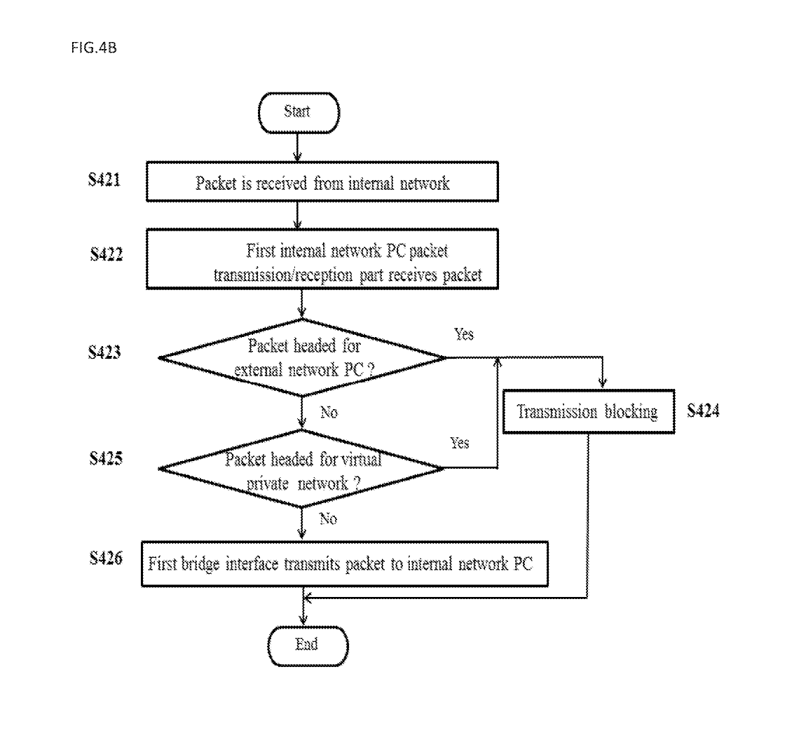

Referring to FIG. 4A, when a packet is received to the encoded gateway 400 through the external network 500, the external-network packet transmission/reception part 412 receives the packet, at steps S411 and 412.

At this time, the second packet analysis part 430 extracts the destination IP address from the packet received by the external-network-PC packet transmission/reception part 412, and transmits the extracted destination IP address to the second packet processing part 440. Then, the second packet processing part 440 analyzes the IP address received from the second packet analysis part 430. When the packet is determined not to be a packet headed for the external network PC 100B or a policy is set to disallow packet transmission to the external network PC 100B from the external network 500, the second packet processing part 440 blocks packet transmission to the external network PC 100B, at steps S413 and S414.

However, when the packet received by the external-network packet transmission/reception part 412 is determined to be a packet headed for the external network PC 100B or a policy is set to allow transmission to the external network PC 100B, the packet received by the external-network packet transmission/reception part 412 is transmitted to the external network PC 100B through the second virtual-private-network packet transmission/reception 411, the virtual private network 600, and the first virtual-private-network packet transmission/reception part 222 and the external-network-PC packet transmission/reception part 221 of the network division apparatus 200, at steps S415 to S417.

Referring to FIG. 4B, when the packet is received to the network division apparatus 200 through the internal network 300, the first internal-network packet transmission/reception part 212 receives the packet, at steps S412 and S422.

At this time, the first packet analysis part 230 extracts the destination IP address from the packet received by the first internal-network packet transmission/reception part 212, and transmits the extracted destination IP address to the first packet processing part 240. Then, the first packet processing part 240 analyzes the IP address received from the first packet analysis part 230. When the packet is determined to be a packet headed for the external network PC 100B or the virtual private network 600, the first packet processing part 240 blocks packet transmission to the external network PC 100B or the virtual private network 600, at step S423 to S425.

However, when the packet received from the internal network 300 is determined to be a packet headed for the internal network PC 100A based on the analysis result for the destination IP address of the packet received by the first internal-network packet transmission/reception part 212, the packet received by the first internal-network packet transmission/reception part 212 is transmitted to the internal network PC 100A through the internal-network-PC packet transmission/reception part 211, at step S426.

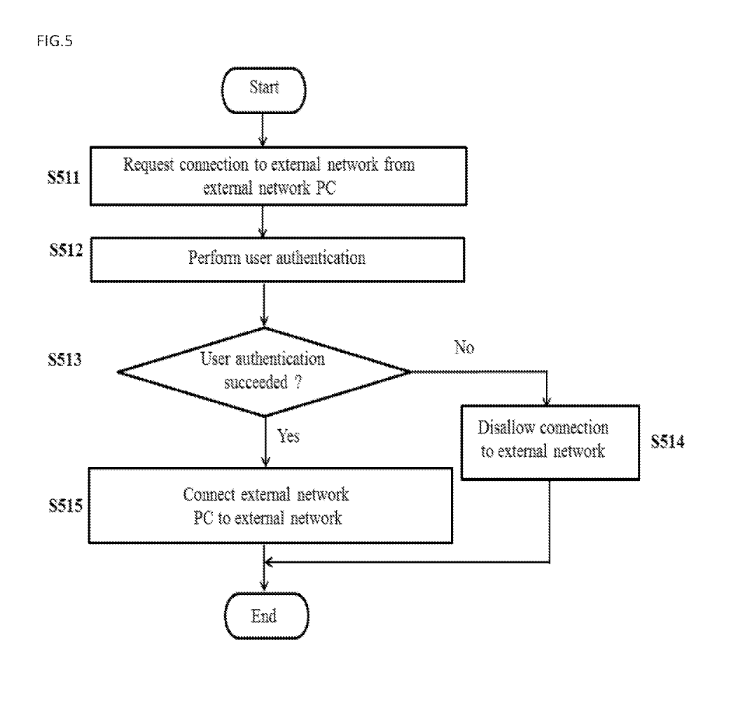

Referring to FIG. 5, when the user requests a connection to the external network 500 from the external network PC 100B in a state where the network division apparatus 200 is connected to the encoded gateway 400 through the virtual private network 600, the network division system performs user authentication, at steps S511 and S512.

When the user authentication is determined to have failed, the network division system disallows the request for connection to the external network 500 at steps S513 and S514.

However, when the user authentication is determined to have succeeded, the network division system allows the connection to the external network 500 from the external network PC 100B through the above-described path, at step S515.

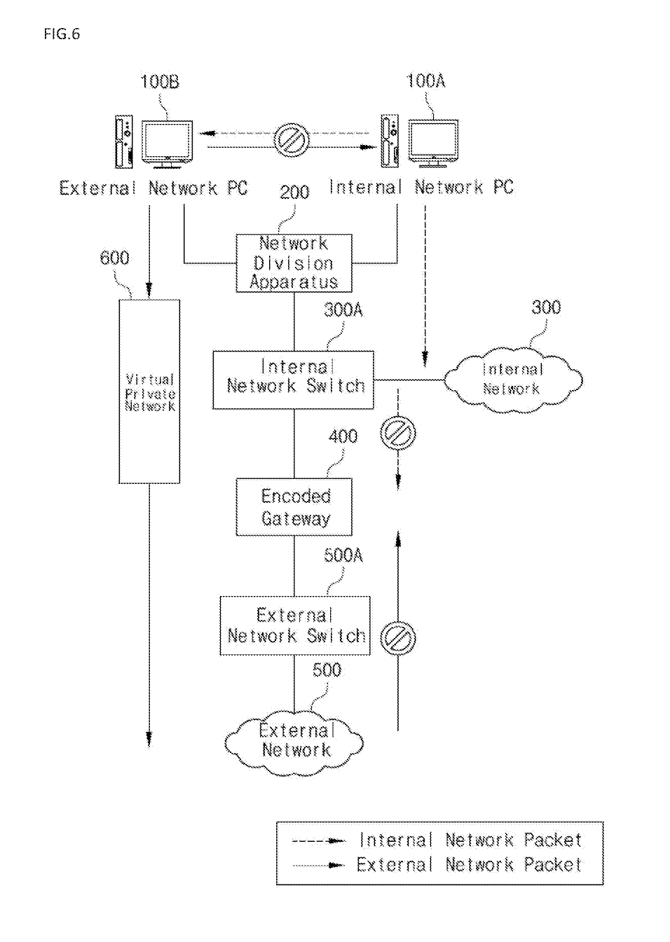

FIG. 6 is a conceptual view illustrating connections of the network division system using a virtual private network according to the embodiment of the present invention. As described above, the network division system disallows the connection between the internal network PC 100A and the external network PC 100B through the network division apparatus 200, disallows the connection between the internal network PC 100A and the encoded gateway 400, and disallows the connection between the external network 500 and the internal network 300 through the encoded gateway 400.

However, the network division system can connect the internal network PC 100A to the internal network 300, and connect the external network PC 100B to the external network 500 through the virtual private network 600.

While various embodiments have been described above, it will be understood to those skilled in the art that the embodiments described are by way of example only. Accordingly, the disclosure described herein should not be limited based on the described embodiments.

1. A network division system using a virtual private network, comprising:
an external network PC and internal network PC connected to a plurality of network division apparatuses;
a virtual private network and internal network connected to the network division apparatuses; and
an external network,
wherein the network division system extracts the destination IP addresses of packets transmitted or received to the internal network PC or the internal network and the destination IP addresses of packets transmitted or received to the external network PC or the virtual private network, and blocks a part of the packets transmitted or received to the internal network PC or the internal network and a part of the packets transmitted or received to the external network PC or the virtual private network, based on the extracted IP addresses.

2. The network division system of claim 1, further comprising an encoded gateway configured to connect the external network to the virtual private network and the internal network,
wherein the network division system extracts the destination IP addresses of packets transmitted or received among the external network, the virtual private network and the internal network, and blocks a part of the packets transmitted or received among the external network, the virtual private network and the internal network, based on the extracted IP addresses.

3. A network division system using a virtual private network, comprising:
an external network PC and internal network PC connected to a plurality of network division apparatuses;
a virtual private network and internal network connected to the network division apparatuses; and
an external network,
wherein the network division apparatus comprises:
a first bridge interface configured to transmit or receive packets between the internal network PC and the internal network;
a second bridge interface configured to transmit or receive packets between the external network PC and the virtual private network;
a first packet analysis part configured to extract the destination IP addresses of packets transmitted or received between the first bridge interface and the internal network PC or the internal network and the destination IP addresses of packets transmitted or received between the second bridge interface and the external network PC or the virtual private network; and
a first packet processing part configured to block a part of the transmitted or received packets, based on the extracted IP addresses.

4. The network division system of claim 3, wherein the first bridge interface comprises:
an internal-network-PC packet transmission/reception part configured to transmit or receive packets to or from the internal network PC; and
a first internal-network packet transmission/reception part configured to transmit or receive packets to or from the internal network.

5. The network division system of claim 3, wherein the second bridge interface comprises:
an external-network-PC packet transmission/reception part configured to transmit or receive packets to or from the external network PC; and
a first virtual-private-network packet transmission/reception part configured to transmit or receive packets to or from the virtual private network.

6. The network division system of claim 3, wherein the first packet processing part controls the second bridge interface to block transmission of packets headed for the internal network PC from the external network PC.

7. The network division system of claim 3, wherein the first packet processing part controls the first bridge interface to block transmission of packets headed for the external network PC from the internal network PC.

8. The network division system of claim 3, further comprising an encoded gateway configured to connect the external network to the virtual private network and the internal network,
wherein the encoded gateway comprises:
a third bridge interface configured to transmit or receive packets between the virtual private network and the external network;
a second internal-network packet transmission/reception part configured to transmit or receive packets to or from the internal network;
a second packet analysis part configured to analyze packets transmitted or received to the third bridge interface and the second internal-network packet transmission/reception part and extracts the destination IP addresses of the packets; and
a second packet processing part configured to block a part of the packets transmitted through the third bridge interface based on the destination IP addresses extracted by the second packet analysis part.

9. The network division system of claim 8, wherein the third bridge interface comprises:
a second virtual-private-network packet transmission/reception part configured to transmit or receive to or from the virtual private network; and
an external-network packet transmission/reception part configured to transmit or receive packets to or from the external network.

10. The network division system of claim 8, wherein the second packet processing part controls the third bridge interface to block transmission of a packet which is headed for the internal network after being received from the external network, among the packets received through the third bridge interface.

11. The network division system of claim 8, wherein the second packet processing part blocks transmission of a packet which is headed for the internal network after being received from the second internal-network packet transmission/reception part, among the packets received through the third bridge interface.

12. The network division system of claim 8, wherein the second packet processing part allows or blocks transmission of a packet which is headed for the external network PC after being received from the external network, among the packets received through the third bridge interface, according to a preset policy.

13. A network division method using a virtual private network, comprising the steps of:
(a) analyzing the destination IP address of a packet received to a network division apparatus from an external network PC, and blocking transmission of the packet when the packet is a packet headed for an internal network PC or internal network or allowing transmission of the packet when the packet is a packet headed for an external network; and
(b) analyzing the destination IP address of a packet received to the network division apparatus from the internal network PC, and blocking transmission of the packet when the packet is a packet headed for the external network PC or a virtual private network or allowing transmission of the packet when the packet is a packet headed for the internal network.

14. The network division method of claim 13, wherein the step (a) comprises:
receiving a packet transmitted from the external network PC;
extracting the destination IP address from the received packet, and analyzing the extracted destination IP address; and
blocking transmission of the packet when the packet is determined to be a packet headed for the internal network PC or determined not to be a packet headed for the external network based on the IP address analysis result, or allowing transmission of the packet when the packet is determined to be a packet headed for the external network through the network division apparatus.

15. The network division method of claim 13, wherein the step (b) comprises:
receiving the packet transmitted to the network division apparatus from the internal network PC;
extracting the destination IP address from the received packet, and analyzing the extracted destination IP address; and
blocking transmission of the packet when the packet is determined to be a packet headed for the external network PC or the virtual private network based on the IP address analysis result, or allowing transmission of the packet when the packet is determined to be a packet headed for the internal network.

16. The network division method of claim 13, further comprising the step (c) of analyzing the destination IP address of a packet received to an encoded gateway from the external network, and blocking transmission of the packet when the packet is not a packet headed for the external network PC or a policy is set to disallow packet transmission to the external network PC from the external network, or allowing transmission of the packet to the external network PC through the virtual private network when the packet is a packet headed for the external network PC or a policy is set to allow packet transmission to the external network PC.

17. The network division method of claim 16, wherein the step (c) comprises:
receiving the packet transmitted to the encoded gateway through the external network;
extracting the destination IP address from the received packet, and analyzing the extracted destination IP address; and
blocking transmission of the packet when the packet is determined not to be a packet headed for the external network PC based on the IP address analysis result or a policy is set to disallow packet transmission to the external network PC from the external network, or allowing transmission of the packet to the external network PC through the virtual private network and the network division apparatus when the received packet is determined to be a packet headed for the external network PC or a policy is set to allow packet transmission to the external network PC.

18. The network division method of claim 16, further comprising the step of performing user authentication when a user requests a connection to the external network from the external network PC in a state where the network division apparatus is connected to the encoded gateway through the virtual private network, and allowing or disallowing the request for connection to the external network according to whether the user authentication fails or succeeds.

19. The network division method of claim 13, further comprising the step (d) of analyzing the destination IP address of a packet transmitted to the network division apparatus from the internal network, and blocking transmission of the packet when the packet is a packet headed for the external network PC or the private virtual network or allowing transmission of the packet to the internal network PC when the packet is a packet headed for the internal network PC.

20. The network division method of claim 19, wherein the step (d) comprises:
receiving the packet transmitted to the network division apparatus through the internal network;
extracting the destination IP address from the received packet, and analyzing the extracted destination IP address; and
blocking transmission of the received packet when the packet is determined to be a packet headed for the external network PC or the virtual private network based on the IP address analysis result, or allowing transmission of the packet to the internal network PC when the packet is determined to be a packet headed for the internal network PC.
